(19) United States
(12) Patent Application Publication
(10) Pub. No.: US 2011/0215595 A1
(43) Pub. Date: Sep. 8, 2011

(54) DUAL-HOOK LATCHING MECHANISM

(75) Inventors: ZE-BO LIN, Shenzhen City (CN); SHOU-JI LIU, Shenzhen City (CN); FENG DAI, Shenzhen City (CN); TE-SHENG JAN, Tu-Cheng (TW); YU-TAO CHEN, Tu-Cheng (TW); CHUN-CHE YEN, Tu-Cheng (TW)

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/894,180

(22) Filed: Sep. 30, 2010

(30) Foreign Application Priority Data
Mar. 2, 2010 (CN) 201010116109.3

(51) Int. Cl. E05C 19/10

(52) U.S. Cl. 292/95

(57) ABSTRACT

A dual-hook latch formed on a housing of an electronic device includes an arm and two protrusions. The arm protrudes from the housing and defines an opening therein. The two protrusions are formed at opposite sides of the arm. The two protrusions are arranged at an end of the opening. The widths of the two protrusions are smaller than that of the opening.

### BACKGROUND

1. Technical Field

The present disclosure relates to a dual-hook latch.

2. Description of Related Art

A dual-hook latch can be used to fix two adjacent circuit boards together. Usually, a dual-hook latch is formed in a mold consisting of two blocks that cooperatively define a mold cavity.

Referring to FIGS. 1 and 2, a conventional dual-hook latch 40 employed on the housing 50 of an electronic device includes an arm 41 and two hooks 42, 43. The two hooks 42, 43 are arranged at opposite sides of the arm 41. Two blocks 60, 70 comprise a mold to form the latch 40. The two blocks 60, 70 are tightly clamped together to cooperatively define a mold cavity 61. Molten plastic is injected into the cavity 61 to form the latch 40. After the molten plastic has been solidified, the blocks 60, 70 are parted and the latch 40 is removed. The blocks 60, 70 suffer wear over time from being pressed tightly together repeatedly.

Therefore, what is needed is a dual-hook latch alleviating the limitations described above.

### BRIEF DESCRIPTION OF THE DRAWINGS

The components in the drawings are not necessarily drawn to scale, the emphasis instead being placed upon clearly illustrating the principles of a dual-hook latch. Moreover, in the drawings, like reference numerals designate corresponding parts throughout the several views.

FIGS. 1 and 2 show a conventional dual-hook latch and two blocks of a mold for forming the conventional dual-hook latch.

FIG. 3 is an isometric view of a dual-hook latch in accordance with an exemplary embodiment.

FIG. 4 is a side view of the dual-hook latch of FIG. 3.

FIG. 5 is a front view of the dual-hook latch of FIG. 3.

FIG. 6 is a back view of the dual-hook latch of FIG. 3.

FIG. 7 shows the dual-hook latch of FIG. 3 and half of a block for forming the dual-hook latch of FIG. 3.

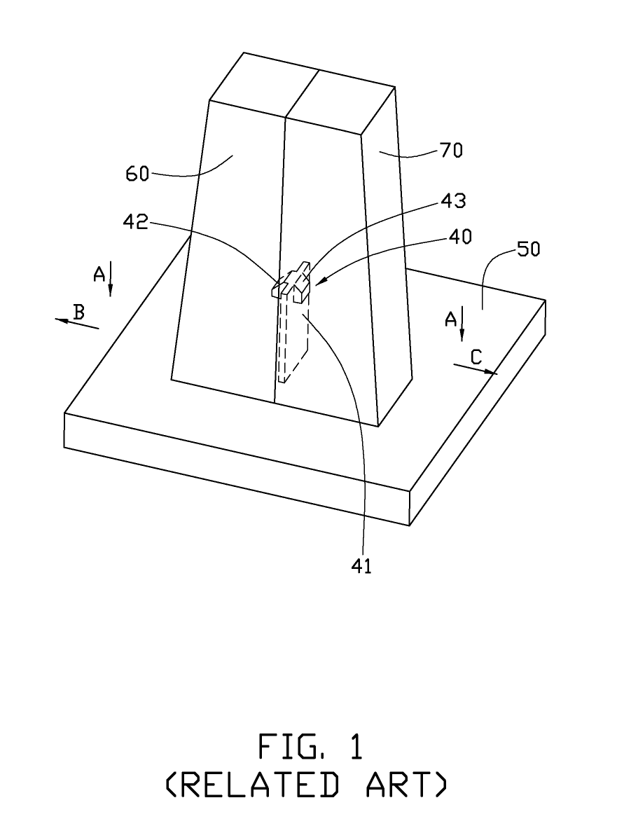

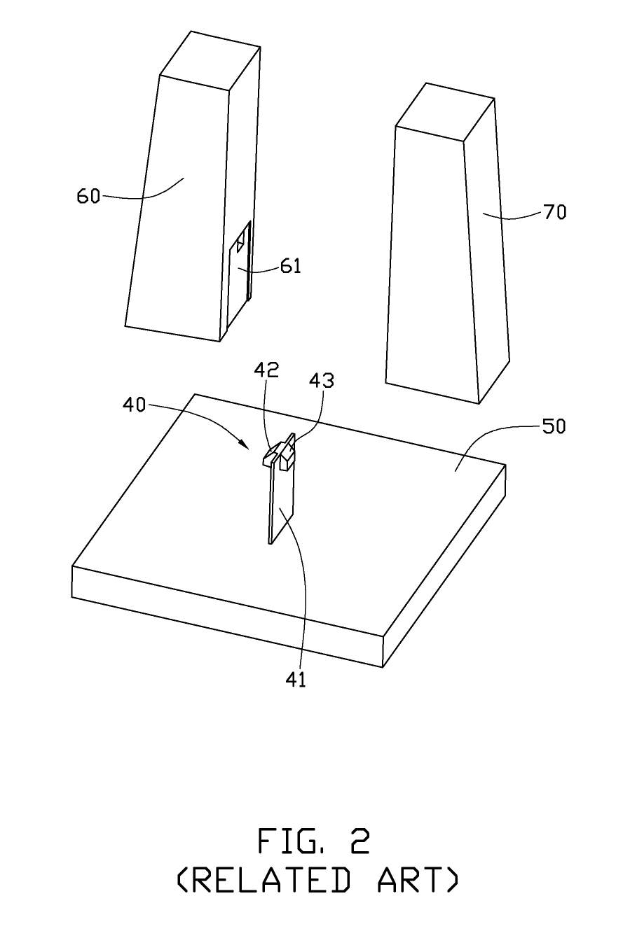

### DETAILED DESCRIPTION

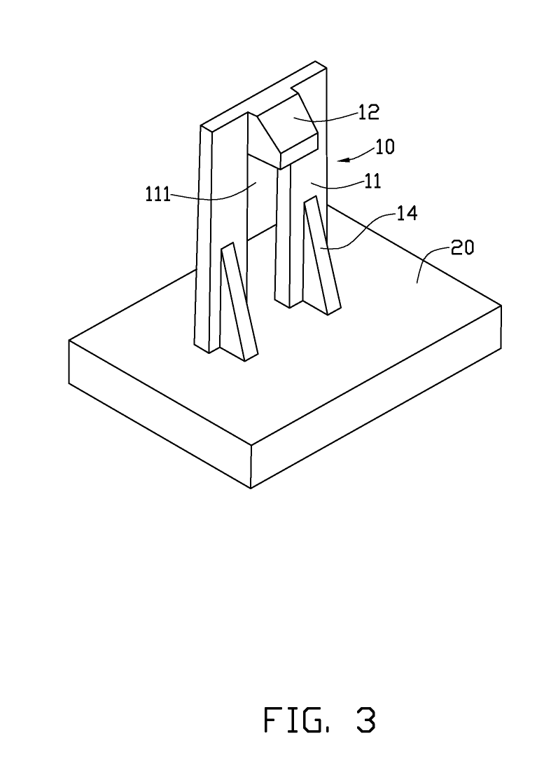

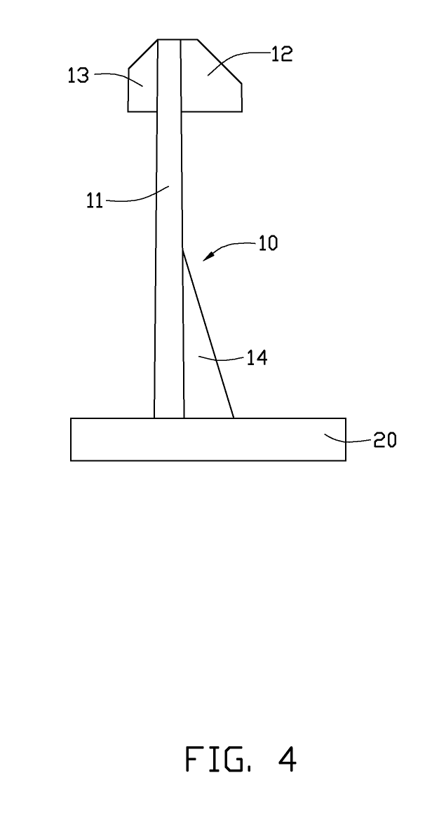

Referring to FIGS. 3 and 4, a dual-hook latch 10 is disclosed according to one embodiment. The dual-hook latch 10 is for use in an electronic device (not shown) to fix two printed circuit boards (PCBs) of the electronic device in place. The dual-hook latch 10 can be integrally formed on a housing 20 of the electronic device. The dual-hook latch 10 includes an arm 11 protruding from the housing 20 and two protrusions 12, 13 formed at opposite sides of the arm 11, away from the housing.

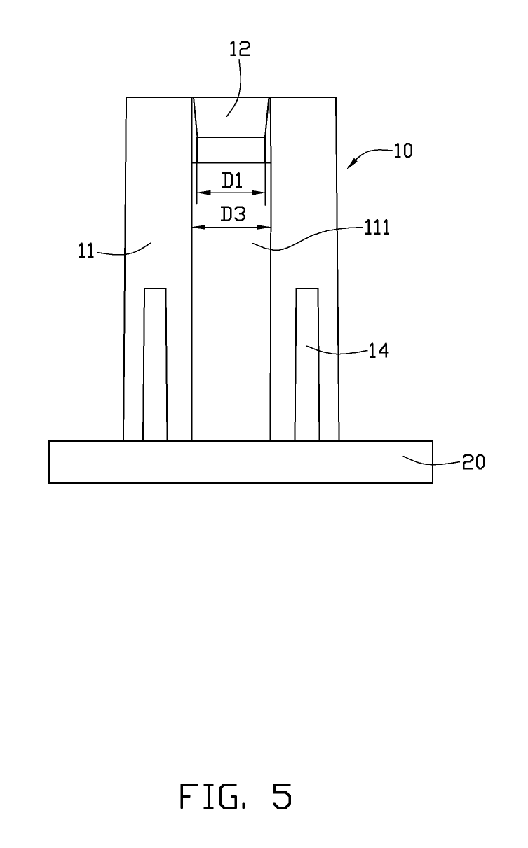

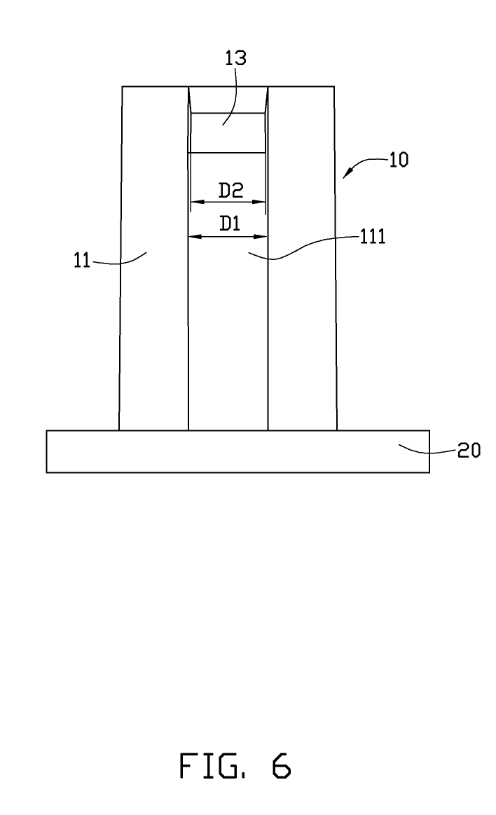

The arm 11 is a rectangular plate and defines an opening 111 extending from the housing 20 to the protrusions 12 and 13. Referring also to FIGS. 5 and 6, the widths D1, D2 of the two protrusions 12, 13 are smaller than the width D3 of the opening 111.

In the embodiment, the dual-hook latch 10 further includes two ribs 14 protruding from the arm 11 for connecting the arm 11 to the housing 20. The ribs 14 can be arranged at opposite sides of the opening 111.

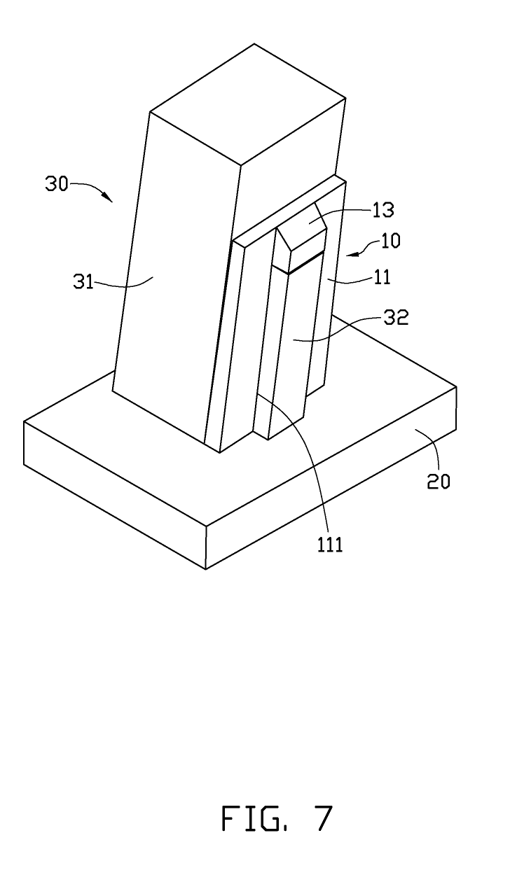

Referring to both FIG. 3 and FIG. 7, when forming the dual-hook latch 10 by plastic molding, only one block 30 is employed. The block 30 includes a main body 31. The main body 31 and a conventional mold (not shown) corporately define a cavity (not shown) for receiving molten plastic that solidifies to form the protrusions 12, 13. The block 30 further includes a protruding block 32 received in the cavity for forming the opening 111. In the embodiment, the protruding block 32 and the conventional mold are employed instead of one of the two conventional blocks 60, 70. The block 30 and the conventional mold are easily parted and the latch 10 is removed.

Due to the structure of the dual-hook latch 10, only one block 30 is employed, thereby avoiding using two blocks that may be worn out because of being repeatedly tightly pressed against each other.

Although the present disclosure has been specifically described on the basis of the embodiments thereof, the disclosure is not to be construed as being limited thereto. Various changes or modifications may be made to the embodiments without departing from the scope and spirit of the disclosure.

What is claimed is:

1. A dual-hook latch formed on a housing of an electronic device, the hook comprising:
an arm protruding from the housing and defining an opening therein; and
two protrusions formed at opposite sides of the arm;
wherein the two protrusions are arranged at an end of the opening, and the widths of the two protrusions are smaller than that of the opening.

2. The dual-hook latch as described in claim 1 further comprising two ribs protruding from the arm for connecting the arm to the housing.

3. The dual-hook latch as described in claim 2, wherein the ribs are arranged at opposite sides of the opening.

4. The dual-hook latch as described in claim 1, wherein the dual-hook latch is integrally formed on the housing.

5. The dual-hook latch as described in claim 1, wherein the opening extends from the housing to the two protrusions.
